(19) United States
(12) Patent Application Publication
(10) Pub. No.: US 2010/0004066 A1
(43) Pub. Date: Jan. 7, 2010

(54) One Degree of Freedom Diaphragm Coupling

(76) Inventor: Keith Kowalski, Bethlehem, CT (US)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 12/439,244

(22) PCT Filed: Aug. 29, 2006
(86) PCT No.: PCT/US2006/033660

§ 371 Date: Feb. 27, 2009

(51) Int. Cl. F16D 3/68

(52) U.S. Cl. 464/161

(57) ABSTRACT

In a preferred embodiment, an apparatus (100), including: a diaphragm coupling member (110); the diaphragm coupling member (110) having a generally ball shaped central portion; the ball shaped central portion having a first surface (130) engaging a complementarily shaped portion of a cover plate (132); the ball shaped central portion having a second surface (134) engaging a complementarily shaped portion of a drive plate (136); and the cover plate (132) and the drive plate (136) being co-engaged (at 150) such as to remove any clearance between the ball shaped central portion and the complementarily shaped portion of the cover plate (132) and the complementarily shaped portion of the drive plate (136).

### TECHNICAL FIELD

The present invention relates to lead screws generally and, more particularly, but not by way of limitation, to a novel, one degree of freedom diaphragm coupling for a lead screw.

### BACKGROUND ART

In order to create linear motion from a rotary motor, a lead screw is often used. This lead screw is rotated and a nut translates motion from rotary to linear. The attachment of the lead screw can be done by several methods.

One method is the use of an integral threaded shaft. This method is suitable for relatively short travel lengths. For longer shafts, it often becomes impractical to employ this method and making the shaft from one piece often adds unnecessary cost. In addition, packaging and shipping problems are presented.

Another method is the use of a rigid coupling. This method may be used to simplify the shaft and allow for a longer threaded section. For long shafts, an end bearing support may be used. This system presents the problem that extremely close alignment of the motor and end bearing is required, since the system is rigid. Because of manufacturing tolerances, it is often difficult to maintain shaft alignment with the motor unless made with the utmost precision. These systems are prone to binding and misalignment as well as fatigue.

A further method is the use of a compliant coupling. This method often is used in order to alleviate misalignment problems. These couplings allow angular misalignment, but, because of their design, are not stiff axially and may not maintain the centerline of the motor and the threaded shafts. This requires the use of a second bearing support.

Some designs, such as a universal joint, are stiff axially and maintain a common shaft centerline, but are not designed for the high axial loads a threaded shaft can produce and often are mechanically complex.

Accordingly, it is a principal object of the present invention to provide a coupling for a lead screw that overcomes the above disadvantages.

It is a further object of the present invention to provide such a coupling that can withstand high axial loads.

It is another object of the present invention to provide such a coupling that allows for angular shaft misalignment.

It is an additional object of the present invention to provide such a coupling that is axially stiff in both directions.

Yet a further object of the present invention is to provide such a coupling that generally maintains a common shaft centerline.

Yet another object of the present invention is to provide such a coupling that can transmit torque.

Yet an additional object of the present invention is to provide such a coupling that is mechanically simple.

Other objects of the present invention, as well as particular features, elements, and advantages thereof, will be elucidated in, or be apparent from, the following description and the accompanying drawing figures.

### DISCLOSURE OF INVENTION

The present invention achieves the above objects, among others, by providing, in a preferred embodiment, an apparatus, comprising: a diaphragm coupling member; said diaphragm coupling member having a generally ball shaped central portion; said ball shaped central portion having a first surface engaging a complementarily shaped portion of a cover plate; said ball shaped central portion having a second surface engaging a complementarily shaped portion of a drive plate; and said cover plate and said drive plate being co-engaged such as to remove any clearance between said ball shaped central portion and said complementarily shaped portion of said cover plate and said complementarily shaped portion of said drive plate.

### BRIEF DESCRIPTION OF DRAWINGS

Understanding of the present invention and the various aspects thereof will be facilitated by reference to the accompanying drawing figures, provided for purposes of illustration only and not intended to define the scope of the invention, on which:

FIG. 1 is a side elevation view of a motor with an integral threaded lead screw.

FIG. 2 is a side elevational view of a motor with a rigid coupling disposed between the shaft of the motor and the proximal end of a threaded lead screw.

FIG. 3 is a side elevational view of a motor with a rigid coupling disposed between the shaft of the motor and a threaded lead screw and with a support bearing disposed at the distal end of the lead screw.

FIG. 4 is a side elevational view of a motor with a compliant coupling disposed between the shaft of the motor and a threaded lead screw and with support bearings disposed at the distal and proximal ends of the lead screw.

FIG. 5 is a fragmentary, side elevational view, partially in cross-section, of the coupling according to one embodiment of the present invention attached to a threaded lead screw and the shaft of a motor.

FIG. 6 is a side elevational, exploded view of the coupling of FIG. 5.

FIG. 7 is a lead screw end/side isometric view of the diaphragm coupling member of FIG. 5.

FIG. 8 is a motor end/side isometric view of the diaphragm coupling member of FIG. 5.

FIG. 9 is a fragmentary, exploded isometric view of the diaphragm coupling of FIG. 5 with a lead screw and a motor shaft.

FIG. 10 is an assembled isometric view of the elements shown on FIG. 9.

FIG. 11 is an isometric view of the diaphragm coupling of the present invention mounted on a motor.

FIGS. 12-15 are end/side isometric views of alternative embodiments of the present invention.

### BEST MODE FOR CARRYING OUT THE INVENTION

Reference should now be made to the drawing figures, provided for purposes of illustration only, and on which the figure numerals in parentheses (when used) refer the reader to the figure in which the element(s) being described are more fully shown, although the element(s) may be shown on other figures also.

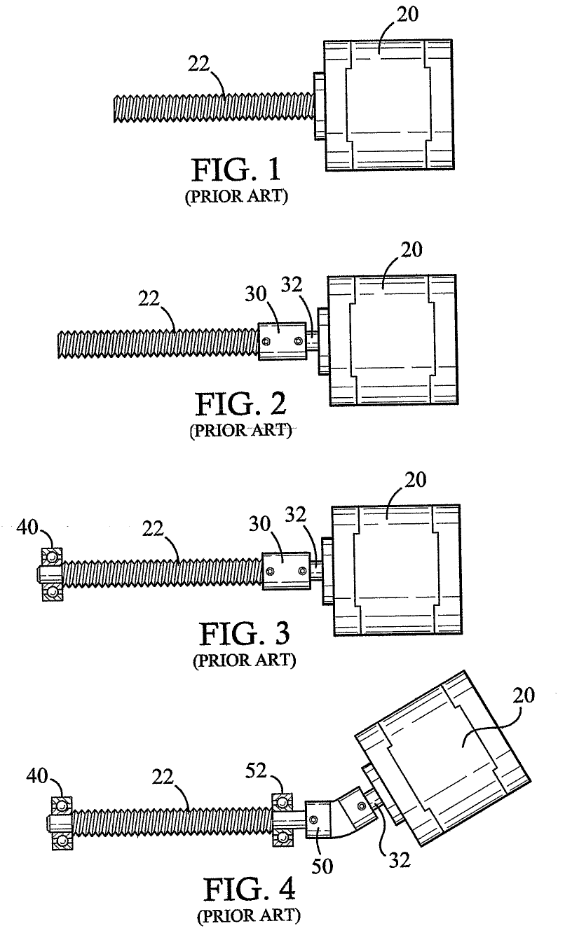

FIG. 1 illustrates a motor 20 with an integral threaded lead screw 22.

FIG. 2 illustrates a rigid coupling 30 disposed between the shaft 32 of motor 20 and the proximal end of threaded lead screw 22.

FIG. 3 illustrates rigid coupling 30 disposed between shaft 32 of motor 20 and threaded lead screw 22 and with a support bearing 40 disposed at the distal end of the threaded lead screw 22.

FIG. 4 illustrates a compliant coupling 50 disposed between shaft 32 of motor 20 and threaded lead screw 22, with support bearings 40 and 52 disposed, respectively, at the distal and proximal ends of the threaded lead screw.

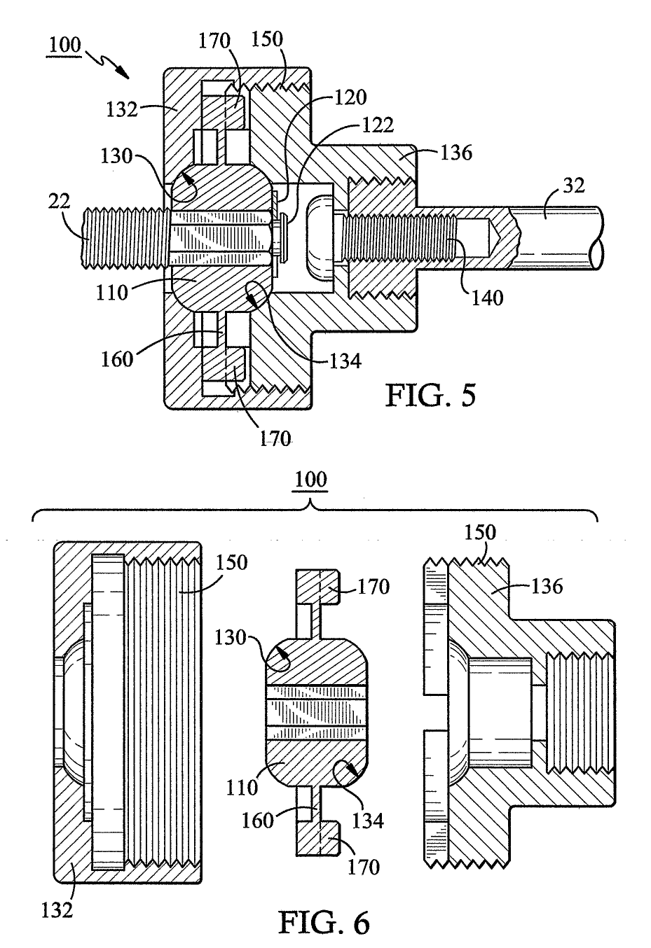

FIG. 5 illustrates a diaphragm coupling according to one embodiment of the present invention, generally indicated by the reference numeral 100, and disposed between shaft 32 of motor 20 (FIGS. 1-4) and threaded lead screw 22. Diaphragm coupling 100 includes a diaphragm coupling member 110 disposed on a proximal end of threaded lead screw 22. Diaphragm coupling member 110 may be constructed of any suitable plastic or metallic material, so long as it does not wear and is preferably construction of a plastic material in the D Shore range of from about 50 to about 90. Relative rotation of diaphragm coupling member 110 and threaded lead screw 22 is prevented, in the case shown on FIG. 5 by a hexagonal internal surface of the diaphragm coupling member engaging a complementarily shaped external surface of the threaded lead screw. Other shapes to prevent relative rotation may be provided as well. Diaphragm coupling member 110 is held on the proximal end of threaded lead screw 22 by means of a c-clip 120 disposed between the diaphragm coupling member and a flange 122 formed on the proximal end of the threaded lead screw and the threaded portion of the lead screw engaging the diaphragm coupling member.

Diaphragm coupling member 110 has a first shoulder 130 formed thereon which engages a complementarily shaped surface on a cover plate 132 and a second shoulder 134 formed thereon which engages a complementarily shaped surface on a drive plate 136. As shown on FIG. 5, drive plate 136 is secured to shaft 32 by means of a screw 140, but the drive plate may be constructed of a material similar to the shaft to permit the drive plate to be welded to the shaft. Cover plate 132 is attached to drive plate 136 by threads 150 to remove any clearance in the ball portion of diaphragm coupling member 110. Diaphragm coupling member 110 has an intermediate diaphragm web portion 160 and at the distal end of the diaphragm coupling member are four protrusions 170 formed thereon (only two visible on FIG. 5) which loosely fit into complementarily shaped portions of drive plate 136 to accommodate slight axial misalignment of threaded lead screw 22 and shaft 32. Of course, fewer or greater than four protrusions 170 may be employed.

Diaphragm coupling member 110 is preferable formed of a soft plastic by injection molding. The stiffness of diaphragm coupling member 110 depends on geometry and flexure required. Cover plate 132 and 136 are formed of a harder material than diaphragm coupling member 110, such as a metallic material.

FIG. 6 is an exploded illustration of the elements of diaphragm coupling 100.

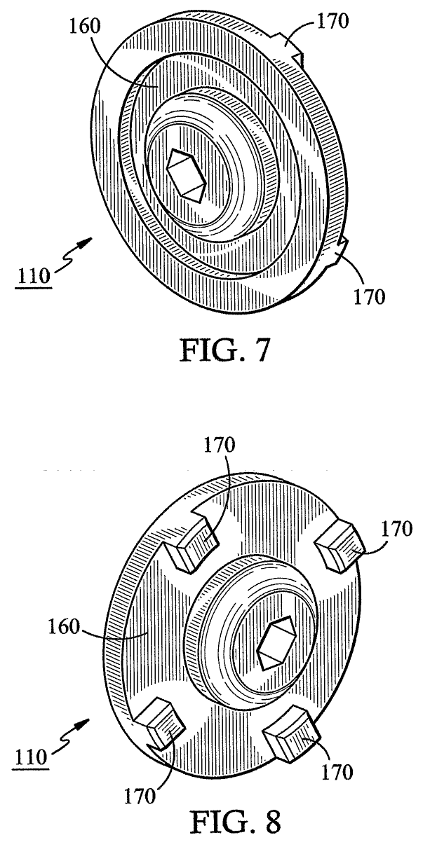

FIG. 7 is an isometric view of diaphragm coupling member 110 from the proximal end of threaded lead screw 22.

FIG. 8 is an isometric view of diaphragm coupling member 110 from the proximal end of shaft 32. It can be seen on FIG. 8 that all protrusions 170 are shown.

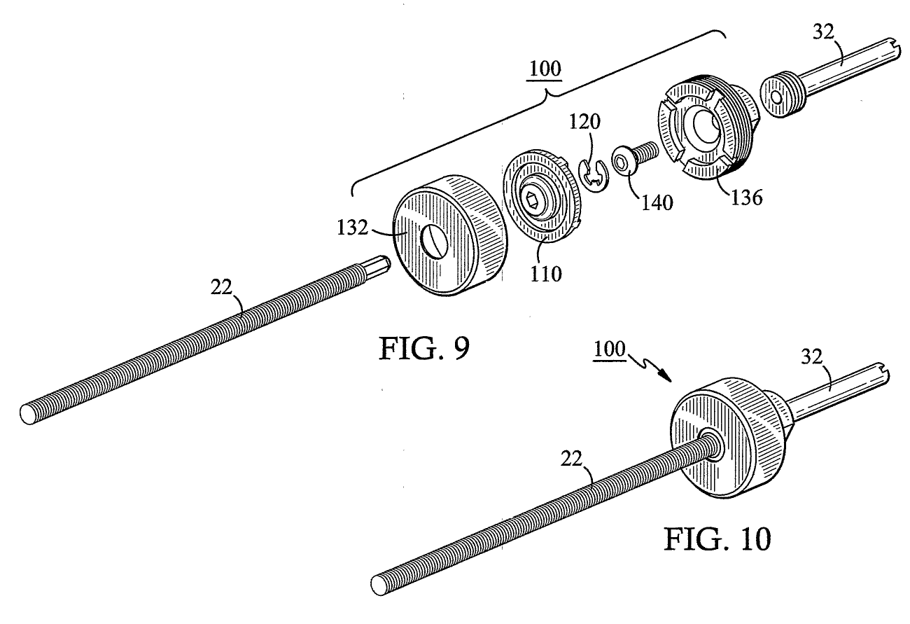

FIG. 9 is an exploded isometric view of diaphragm coupling 100 with threaded lead screw 22 and shaft 32.

FIG. 10 is an assembled isometric view of assembled elements of FIG. 9.

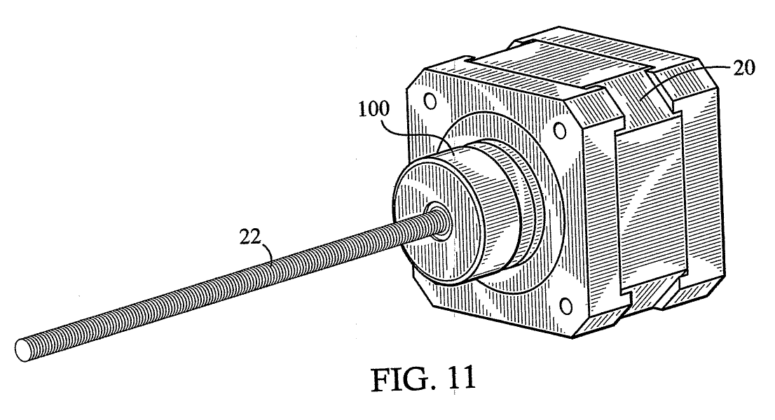

FIG. 11 is an isometric view of diaphragm coupling 100 assembled to motor 20 and lead screw 22.

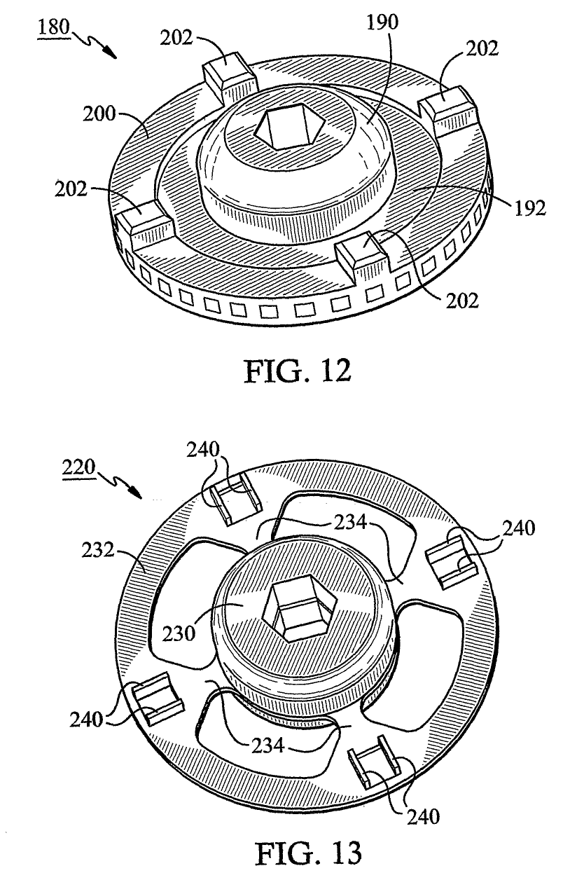

FIG. 12 illustrates a further embodiment of a diaphragm coupling of the present invention, generally indicated by the reference numeral 180. Diaphragm coupling 180 includes a generally ball-shaped central portion 190 and an integrally molded web portion 192, constructed of an elastomer. Molded over web portion 192 is a substantially rigid member 200, preferably formed of an injection molded plastic, which includes four protrusions 202.

FIG. 13 illustrates another embodiment of the diaphragm coupling of the present invention, generally indicated by the reference numeral 220. Diaphragm coupling 220 includes a generally ball-shaped central portion 230 of a plastic molded over a thin metallic portion 232, shown with a web portion comprising four spokes 234. Around the periphery of this metallic portion 232 are eight tabs (two per four openings) 240 to transmit torque.

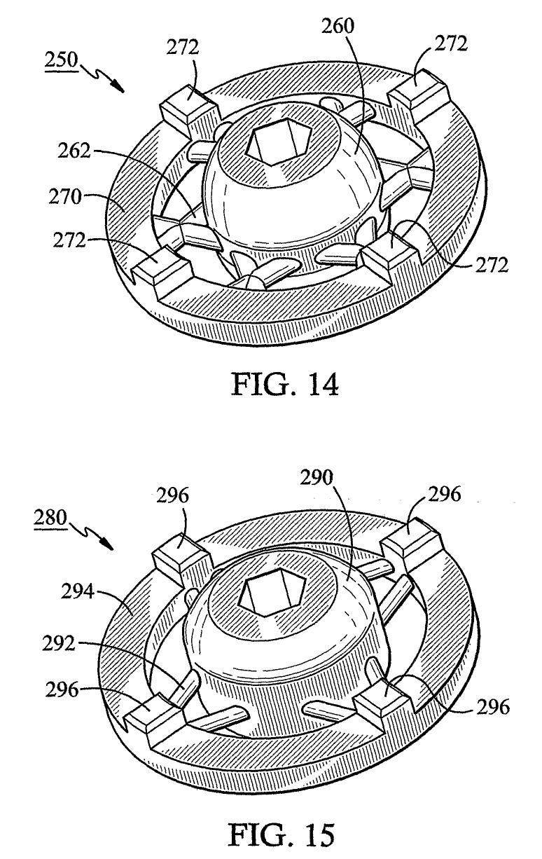

FIG. 14 illustrates an additional embodiment of the diaphragm coupling of the present invention, generally indicated by the reference number 250. Diaphragm coupling 250 has a generally ball-shaped central portion 260 of plastic construction with a web portion comprising plastic spokes, as at 262, formed integrally with the central portion to provide flexibility. A harder portion 270 is molded over the periphery of the plastic spokes 262 and contains four protrusions 272.

FIG. 15 illustrates yet a further embodiment of the present invention this one an entirely metallic diaphragm coupling, generally indicated by the reference numeral 280. Metallic diaphragm coupling 280 includes a generally ball-shaped central portion 290, with a web portion comprising spokes, as at 292, and an outer ring portion 294 bearing four protrusions 296. Diaphragm coupling 280 may be coated with a plastic material.

When the web portion is an elastomeric material, it is constructed of an elastomeric material in the Shore A range of about 60 to about 100. When the web portion is a metallic material, it's thickness is less that about one-half millimeter and is highly elastic, such as spring steel or stainless steel, and it's hardness is in the HRC range of about 30 to about 50. Some non-ferrous materials, such as beryllium copper, will also work, but that is often cost prohibitive. Soft materials, such as aluminum and certain copper alloys would not be suitable.

“Slight misalignment” refers to an angle of about two-and-one-half degrees per side or five degrees of total sweep. “Axial stiffness” refers to an axial displacement of up to about twenty-five microns under load.

In the embodiments of the present invention described above, it will be recognized that individual elements and/or features thereof are not necessarily limited to a particular embodiment but, where applicable, are interchangeable and can be used in any selected embodiment even though such may not be specifically shown.

Spatially orienting terms such as “above”, “below”, “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction and/or method without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

1. A diaphragm coupling for use with a threaded lead screw, the diaphragm coupling comprising:
(a) a diaphragm coupling member disposed on a proximal end of a lead screw,
said diaphragm coupling member having a generally ball shaped central portion; wherein said diaphragm coupling member comprise a first shoulder formed thereon that engages a complementarily shaped portion of a cover plate
and a second shoulder formed thereon that engages a complementarily shaped portion of a drive plate; and
(b) said cover plate and said drive plate are co-engaged to remove any clearance between said ball shaped central portion and said complementarily shaped portion of said cover plate and said complementarily shaped portion of said drive plate.

2. The diaphragm coupling according to claim 1, wherein the diaphragm coupling member comprises a web portion that extends outwardly from the ball shaped central portion and a plurality of protrusions that extend from a distal end of said web portion; wherein the plurality of protrusions extend into complementarily shaped portions of said drive plate.

3. The diaphragm coupling according to claim 1, wherein said drive plate is fixedly attached to a shaft of a motor.

4. The diaphragm coupling according to claim 1, wherein said generally ball shaped portion is fixedly attached to the proximal end of the lead screw.

5. The diaphragm coupling according to claim 1, wherein said diaphragm coupling member is comprises a soft plastic material and said cover plate and said drive plate are formed of a metallic material.

6. The diaphragm coupling according to claim 5, wherein said diaphragm coupling member is formed by injection molding.

7. (canceled)

8. The diaphragm coupling according to claim 2, wherein said web portion comprises a plurality of spokes.

9. The diaphragm coupling according to claim 2, wherein said web portion is an elastomeric material.

10. The diaphragm coupling according to claim 2, wherein said web portion is a metallic material.

11. The diaphragm coupling according to claim 8, wherein the plurality of spokes comprise a metallic material and the central portion of the diaphragm coupling member is molded over the metallic material.

12. The diaphragm coupling according to claim 8, wherein the plurality of spokes comprise a plastic material and the plurality of spokes are formed integrally with the central portion.

13. The diaphragm coupling according to claim 12, wherein a harder plastic portion is molded over the periphery of the plurality of spokes, said harder plastic portion comprising the plurality of protrusions that extend into the complementary shaped portions of the drive plate.

14. The diaphragm coupling according to claim 1, wherein the diaphragm coupling member is held on the proximal end of the lead screw by means of a clip.

15. The diaphragm coupling according to claim 11, wherein a plurality of tabs are arranged around the periphery of the metallic portion, wherein said plurality of tabs are arranged in pairs and are configured to transmit torque.
